(19) United States
(12) Patent Application Publication
(10) Pub. No.: US 2026/0299780 A1
(43) Pub. Date: Oct. 1, 2026

(54) System and Method for Partial Memory Integrity

(71) Applicant: TEXAS INSTRUMENTS INCORPORATED, Dallas, TX (US)

(72) Inventors: Abhinav Parashar, Bangalore (IN); Anand Kumar G., Bangalore (IN); Sverre Brubak, Oslo (NO)

(21) Appl. No.: 19/096,487

(22) Filed: Mar. 31, 2025

(51) Int. Cl. G06F 3/06

(52) U.S. Cl. CPC G06F 3/0608; G06F 3/0659; G06F 3/0673

(57) ABSTRACT

A system includes a memory controller having capability to provide partial memory integrity protection, no memory integrity protection, or full memory integrity protection for a set of memory regions.

### TECHNICAL FIELD

The present application relates to circuits, generally, and more specifically to systems and methods for partial memory integrity.

### BACKGROUND

In electronic systems, memory (e.g., static random access memory (SRAM), dynamic random access memory (DRAM), erasable programmable read only memory (EPROM), etc.) is often provided to store instructions and/or data. To enhance reliability, the memory may include storage for memory integrity data that is used to detect or correct faults or data value changes in one or more bit cells of the memory. The storage provided for memory integrity data may be in addition to the storage provided for data and/or instructions. For example, for a 32-bit data value, four additional bits of parity may be used if byte-wise parity is implemented. For a 64-bit data value, eight additional bits may be used for an 8-bit error correction code (ECC code) that provides single-bit error correction or double-bit error detection.

### SUMMARY

According to one embodiment, an apparatus includes: a memory comprising a first set of memory regions and a second set of memory regions, wherein the first set of memory regions is configured to store user data, and wherein the second set of memory regions is configured to store the user data or integrity data indicative of an integrity status of the user data; and a memory controller, coupled to the memory, wherein the memory controller is configured to: disable a memory integrity operation for a first memory region of the second set of memory regions, such that the first memory region is configured to store the user data instead of the integrity data.

According to another embodiment, a device includes: a processor core; and a memory, coupled to the processor core, wherein the memory is configured to: configure a contiguous address space of the memory for read and write operations and for storing memory integrity data, including designating N memory regions for the read and write operations; and enable memory integrity operations on M of the N memory regions, where N is an integer greater than one, and M is an integer less than N and greater than zero.

According to yet another embodiment, a method includes: configuring, in a memory having a first set of memory regions and a second set of memory regions, the first set of memory regions to store user data; and configuring the second set of memory regions to store the user data or integrity data indicative of an integrity status of the user data, which includes: disabling a memory integrity operation for a first memory region of the second set of memory regions, such that the first memory region is configured to store the user data instead of the integrity data; and enabling the memory integrity operation for a remainder of the second set of memory regions, such that the remainder of the second set of memory regions is configured to store the integrity data instead of the user data.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an illustration of an example system, adapted according to some embodiments;

FIG. 2 is an illustration of an example memory for use in the system of FIG. 1, according to some embodiments;

FIG. 3 is an illustration of example MMRs, according to some implementations;

FIG. 4 is an illustration of example data structures, according to some embodiments;

FIGS. 5-8 is an illustration of an example use cases of the system of FIG. 1, according to some embodiments; and

FIG. 9 is an illustration of an example method, according to some embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The present disclosure is described with reference to the attached figures. The figures are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

Various embodiments provide for systems and methods that allow for partial memory integrity. In one example, a memory controller may be communicatively coupled to at least one memory. In this example, the memory may include random access memory (RAM) (such as static RAM (SRAM), dynamic RAM (DRAM)), erasable read only memory (such as EPROM, EEPROM, flash memory), and/or the like. In some embodiments, the memory may include memory banks, each representing a memory section that may be accessed in parallel with another. Each memory bank may be further divided into memory regions. In one example, each memory region may be 64 kB, though the scope of implementations may be adapted for use with any sized memory region and any quantity of memory banks. Furthermore, a memory bank of the memory may also include smaller memory regions that may be used for memory integrity data. Examples of memory integrity data may include data associated with parity protection, error correction codes (ECC), and/or the like. In one example, each of the smaller regions may be 2 kB, though the scope of implementations may be adapted for use with any sized memory region for memory integrity data.

Thus, in one example, the memory may include a first memory bank and a second memory bank. The first memory bank may include four larger regions, each of the memory regions usable to store data and/or instructions (e.g., user data). The second memory bank may also include four smaller regions, each of those smaller regions usable to store memory integrity data to indicate the integrity status of the user data in a corresponding one of the larger regions of the first memory bank. Of course, the memory may include fewer or more than two banks, and each of the banks may include fewer or more than four regions. Furthermore, though user data and memory integrity data may be stored on different memory banks, in some examples, the memory may include one single bank and the user data and memory integrity data may be stored in different regions of the memory bank.

Various embodiments may include software and/or hardware logic having capability to selectively enable all, none, or a subset of the smaller regions to store user data instead of memory integrity data. For instance, in an example in which only two regions of user data may be desired for memory integrity operations, two of the smaller regions may be set aside for memory integrity data, and the additional two smaller regions may be used to store user data, thereby increasing the amount of memory available to store user data. In another example, the same memory may be re-configured so that none of the smaller regions are used for memory integrity data (e.g., none of the larger memory regions are protected), thereby allowing for the entirety of the bank to be used for storing user data. In yet another example, the same memory may be re-configured so that all of the smaller regions are used for memory integrity data (e.g., all of the larger memory regions are protected).

Such functionality may include one or more memory mapped registers (MMRs), where those MMRs may be used to define which of the larger memory regions (also referred to as main memory regions) are protected. Software or hardware logic may be used to generate data structures, based on the data in the MMRs, to identify a corresponding quantity of the smaller memory regions (also referred to as memory integrity regions) to use for memory integrity. A remaining quantity of the memory integrity regions may be re-used for user data.

Continuing with the example, the main memory regions and the memory integrity regions may be defined within a contiguous address space, beginning at a particular starting address and ending at a particular ending address. The software or hardware logic may be configured to arrange the main memory regions to be contiguous with any remaining memory integrity regions configured to store user data, with the regions used for memory integrity arranged at the end of the address range. As a result, a range of memory addresses that may be used for user data may be contiguous, beginning at the starting address and ending at an address adjacent to a beginning of the memory integrity regions used for memory integrity data.

A potential advantage of some implementations may include the ability to be flexible, providing protection only for desired main memory regions. Thus, there may be added efficiency by selectively avoiding performing memory integrity operations for at least some of the user data.

Another potential advantage of some implementations may include the ability to re-use some of the memory bank, which would otherwise be used for memory integrity data, to store user data. Thus, such implementations may advantageously increase an amount of memory available to store user data.

Yet another potential advantage of some implementations is that the portion of memory available for user data may be contiguous, thereby avoiding a “memory hole.” For instance, in some implementations, no address range used for memory integrity data may be interleaved within an address range used for user data. As a result, software programs, which may read or write to the regions for user data, may be simplified by omitting functionality to avoid the memory hole.

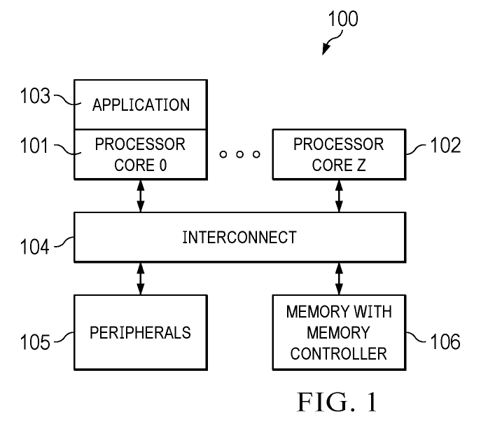

FIG. 1 is an illustration of an example system 100, adapted according to some embodiments. System 100 may include one or more processor cores, illustrated as processor cores 0-Z 101-102. The quantity of processor cores may be Z+1, where Z is an integer zero or greater. Examples of processor cores that may be used include central processing units (CPUs), digital signal processors (DSPs), microcontrollers, reduced instruction set computers, and/or the like. Processor cores 101-102 may be configured to communicate with memory 106, via interconnect 104, to read and write data and access computer-readable instructions.

In one example, the computer-readable instructions may provide functionality for one or more applications, such as application 103, which is illustrated as being run on processor core 101.

Interconnect 104 may include any of a variety of hardware conductors, such as wires, and hardware logic, which may provide for communication among processor cores 101-102, peripherals 105, and memory 106. Peripherals 105 may include any of a variety of appropriate circuits, such as network interfaces, direct memory access components, and/or the like.

Memory 106 is illustrated as including a memory controller. For instance, memory 106 may include one or more memory banks and a memory controller, where the memory controller is configured for performing read and write operations on behalf of processors 101-102 and peripherals 105. Furthermore, the memory controller may be configured to arrange the memory banks into one or more regions, where those regions may include discrete address ranges.

In various embodiments, the memory controller may further be configured for enabling and disabling memory integrity operations for the various memory regions. For instance, the memory controller may be configured to identify one or more main memory regions to be protected and may further be configured to identify memory integrity regions to store memory integrity data and one or more memory integrity regions to store the user data.

In some implementations, system 100 may be implemented on one or more semiconductor chips. For instance, system 100 may be implemented as part of a system on-chip (SOC), having further components (not shown), such as modems, radio frequency (RF), transceivers, and/or the like. In another example, various components of system 100 may be implemented in different semiconductor chips, such as the memory banks themselves being implemented on a different semiconductor chip than the other components of system 100. In any event, the scope of implementations may include any arrangement of various ones of the components on one or more semiconductor chips. Furthermore, in some embodiments, system 100 may include semiconductor devices having the disclosed memory functionalities for various applications. For instance, system 100 may include connectivity products used for communication equipment, radar chips used for advanced driver assistance systems, processors and memory devices used for artificial intelligence and machine learning, microcontrollers used for industrial and enterprise applications, and/or the like.

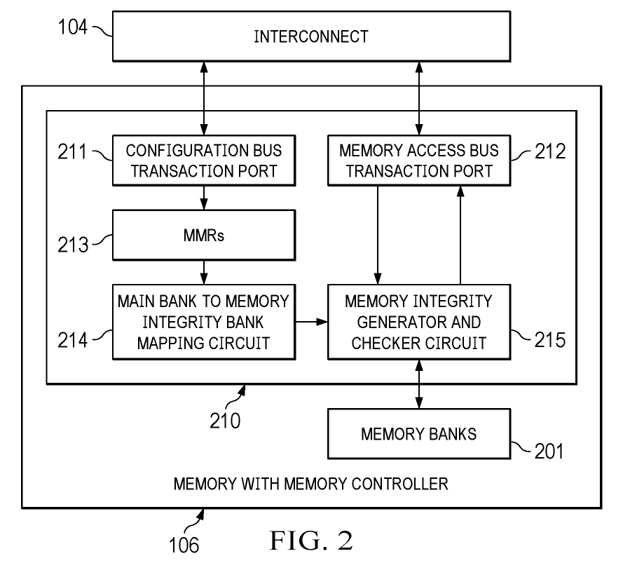

FIG. 2 is an illustration of memory 106 in more detail, according to some embodiments. Memory banks 201 may include an array of bit cells, arranged in rows and columns and which may be written to and read from by the memory controller 210. Memory banks 201 may include one or more memory banks. In one example, each memory bank itself may be a physically separate array of bit cells, under control of memory controller 210, though the scope of implementations may include any configuration of memory banks 201.

In this example, memory controller 210 includes configuration bus transaction port 211, which is configured to receive configuration data via interconnect 104. In one example, the application 103, which runs on processor core 101, may transmit configuration data to memory controller 210 via configuration bus transaction port 211. Examples of configuration data may include an indication of memory region size, an indication of main memory regions to be protected and/or unprotected, and/or the like. Configuration bus transaction port 211 may receive that configuration data and write it to MMRs 213.

Main bank to memory integrity bank mapping circuit 214 may be configured to read configuration data from MMRs 213 and then apply the configuration data to arrange the memory banks 201 into regions and further configured to identify particular ones of the main memory regions to be protected. Main bank to memory integrity bank mapping circuit 214 may also be configured to identify particular ones of the memory integrity regions to store user data and to identify remaining ones of the memory integrity regions to store memory integrity data.

Integrity generator and checker circuit 215 may be configured to perform memory integrity operations based on the mapping performed by main bank to memory integrity bank mapping circuit 214. For instance, for particular ones of the main memory regions that are identified as protected, integrity generator and checker circuit 215 may generate memory integrity data for user data that is written to those particular ones of the main memory regions, store that memory integrity data to corresponding memory integrity regions, and perform checking and/or correction as user data is read from protected ones of the main memory regions. For the ones of the main memory regions that are not protected, integrity generator and checker circuit 215 may perform no memory integrity operations.

Read and write operations may be received from the processor cores 101-102 via interconnect 104. Those read or write operations may be received as transactions on the memory access bus transaction port 212. The read or write operations may result in memory being read from or written to the memory banks 201. Furthermore, each of those read and write operations may or may not include action from the integrity generator and checker circuit 215, depending upon whether the read or write operations are directed to a protected or unprotected main memory region.

The various components 211-215 of memory controller 210 may be implemented in software, hardware logic, or a combination thereof. Furthermore, memory controller 210 may include one or more additional components (not show) to route data and address information for accessing the main bank and memory integrity bank. For instance, when a memory integrity region is configured to store user data, processor cores 101, 102 may provide a request to access user data stored in the memory integrity region. Based on the address requested by the access, memory controller 210 may determine that the request is directed to the memory integrity region and thus route the request to the memory integrity region. In another example, processor cores 101, 102 may encode an indication in an access request to memory banks 201 and, based on the indication, memory controller 210 may determine to route the request to the main bank or the memory integrity bank.

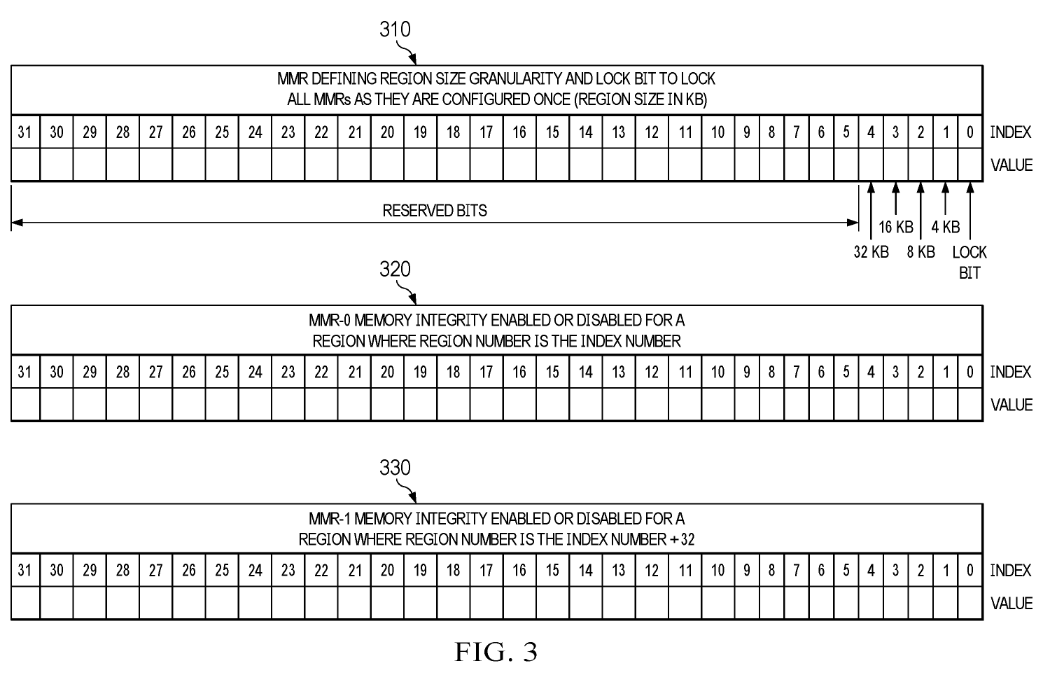

FIG. 3 is an illustration of example MMRs 310, 320, 330, according to some implementations. The MMRs 213 of FIG. 2 may be configured and used as described with respect to MMRs 310, 320, 330 according to various embodiments.

In one embodiment, the MMRs 310, 320, 330 may be populated with data via the configuration bus transaction port 211 and based on instructions from application 103 or another application running on one or more of the processor cores 101-102. For instance, at power up or boot, one or more of the processor cores 101-102 may execute computer-readable instructions, causing the one or more processor cores 101-102 to populate MMRs 310, 320, 330. The configuration data stored in MMRs 310, 320, 330 may be used to arrange memory banks 201 into regions and may configure memory controller 210 to perform read and write operations as well as to perform memory integrity operations as appropriate.

MMR 310 in this example includes 32 bits, having indices 0-31. In this example, 27 of those bits (indices 5-31) are reserved. Further in this example, the bit with index 0 is used as a lock bit, where a 1 may indicate that the content of MMR 310 is locked, and where a 0 may indicate the content of MMR 310 is unlocked. The bits having indices 1-4 are used to indicate a size of the individual ones of the main memory regions. In one example, bit 1 may correspond to a 4 kB region size, bit 2 may correspond to an 8 kB region size, bit 3 may correspond to a 16 kB region size, and bit 4 may correspond to a 32 kB region size. For instance, one of the bits 1-4 may be populated to specify a region size. In one example, bit 1 may be populated with a digital 1 and bits 2-4 may be populated with digital zeros to specify a 4 kB region size for main memory regions. Similarly, bit 2 may be populated with a digital 1 and bits 1 and 3-4 may be populated with digital zeros to specify an 8 kB region size for the main memory regions, and so on.

In an example in which there are two memory banks, providing 128 kB total of main memory region memory space, then a 4 kB region size would result in 32 main memory regions total, an 8 kB region size would result in 16 main memory regions total, a 16 kB region size would result in 8 main memory regions total, and a 32 kB region size would result in four main memory regions total. Of course, these are examples, and sizes for main memory regions, and a total amount of main memory region space in bytes may be scaled as appropriate for a given system.

MMRs 320 and 330 each have 32 bits, and they may be used to indicate which ones of the main memory regions have memory integrity enabled. In a system that may support up to 64 main memory regions, the MMRs 320 and 330 are provided to have a total of 64 bits, each one of the bits corresponding to each one of the 64 main memory regions. In an example in which 32 main memory regions or fewer are configured for use, then MMR 330 may be ignored, and MMR 320 may be used to identify respective memory regions for memory integrity.

For instance, in an example in which there are 32 total memory regions, the bit having index 1 in MMR 310 may be populated with a digital 1, and the bits having indices 2-4 may be populated with digital zeros. Thus, the one or more processors 101-102 may use MMR 320 to indicate which of the main memory regions are enabled for memory integrity and may ignore MMR 330.

Continuing with the example in which there are 32 main memory regions to be configured, each one of the indices 0-31 of MMR 320 may correspond to a respective one of the main memory regions. The one or more processors 101-102 may populate ones of those bits with a digital 1 to indicate that the corresponding region is enabled for memory integrity and may populate the remainder of those bits with a digital 0 to indicate that the corresponding regions are disabled for memory integrity. Thus, if main memory regions 11 and 14 are enabled for memory integrity, then the bits 11 and 14 may be populated with a digital 1, and the remaining bits may be populated with a digital 0.

The concept illustrated in FIG. 3 may be scaled as appropriate for different systems. For instance, a system that may support 256 main memory regions or 512 main memory regions may include more MMRs and/or more bits in each of the MMRs. Furthermore, in some embodiments, memory controller 210 may use other approaches instead of MMRs to configure memory banks 201. For instance, in some embodiments, memory controller 210 may use a separate memory or a portion of the memory banks 201 to pass and store the configuration information.

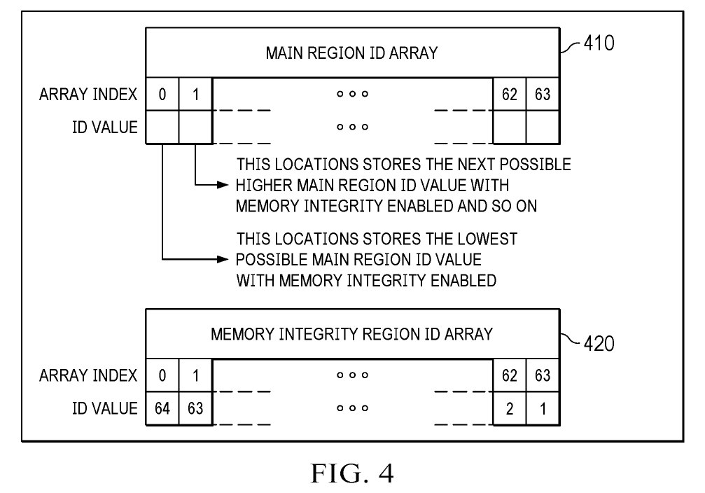

FIG. 4 is an illustration of example data structures 410 and 420, according to some embodiments. For instance, the main bank to memory integrity bank mapping circuit 214 of FIG. 2 may include functionality (e.g., hardware logic) to generate the data structures 410 and 420 based on the data stored in MMRs 213 of FIG. 2. In particular, data structure 410 may indicate the specific main memory regions for which data protection is enabled, whereas data structure 420 may indicate the available memory integrity regions. Based on the values in the data structures 410 and 420, the main bank to memory integrity bank mapping circuit 214 may perform the configuration of main memory regions and memory integrity regions. In one example, data structures 410 and 420 may be stored in flip-flops or other logic circuits, and those flip-flops or other logic circuits may be implemented in a circuit that implements at least some functionality of the main bank to memory integrity bank mapping circuit 214.

Furthermore, in some examples, the functionality to generate the data structures 410 and 420 may be implemented using any appropriate technology, such as hardware logic designed at the register transfer level (RTL).

In an example in which there are 64 main memory regions, those regions may correspond to indices 0-63 of MMRs 320 and 330. Thus, the main memory regions may be designated as main memory regions 0-63. However, the present embodiment may assign IDs that are different from the indices of MMRs 320-330. For instance, the present embodiment adds one to the indices of the main memory regions, so that an ID of 1 in data structure 410 indicates main memory region 0, an ID of 2 in data structure 410 indicates main memory region 1, and so on. Similarly, an ID of 1 in data structure 420 indicates memory integrity region 0, an ID of 2 in data structure 420 indicates memory integrity region 1, and so on. Thus, the main bank to memory integrity bank mapping circuit 214 may identify specific main memory regions and memory integrity regions respectively based on the ID values in the data structures 410 and 420. In some examples, the purpose of using memory region values that avoid 0 may be to reserve 0 to avoid confusion in an example in which no main memory regions are enabled for memory integrity.

As noted above, MMRs 320-330 may the populated with data to indicate ones of the main memory regions for which memory integrity is enabled. The main bank to memory integrity bank mapping circuit 214 may access that data from MMRs 320-330 and use that data to populate data structure 410. In an example in which only main memory regions 11 and 14 are enabled for memory integrity, the bits 11 and 14 of MMR 320 may be populated with a digital one. The main bank to memory integrity bank mapping circuit 214 may assign IDs to memory regions 11 and 14 (IDs 12 and 15) and then generate data structure 410 with those IDs. In the example of FIG. 4, the data structure 410 would be populated in ascending order of IDs, matching an ascending order of the array indices. For instance, the bit having index 0 would be populated with an ID of 12 for main memory region 11, and the bit having index 1 would be populated with an ID of 15 for main memory region 14 in this example. In other words, bit 0 would be populated with the ID for the lowest-indexed main memory region with enabled protection, bit 1 would be populated with the ID for the next lowest-indexed main memory region with enabled protection, and so on.

In an example in which no main memory regions have memory integrity enabled, then data structure 410 may include all zeros or may not be generated at all. In an example in which all main memory regions (e.g., regions 0-63, having IDs 1-64) have memory integrity enabled, then data structure 410 may be completely populated from index 0 to index 63 by IDs 1-64, beginning at index 0 and ending at index 63.

The main bank to memory integrity bank mapping circuit 214 may also generate data structure 420, which may have a same quantity of indices as the data structure 410. For instance, if data structure 410 has 64 indices, then data structure 420 may also have 64 indices 0-63. Furthermore, the memory integrity regions may also be assigned IDs that are different from their indices. So, in this example there are 0-63 memory integrity regions, they may be assigned IDs 1-64. This is similar to the way IDs are assigned to the main memory regions by adding one to each index. Thus, memory integrity regions 0-63 may be assigned IDs 1-64 this example.

In contrast to data structure 410, which is populated in ascending order, data structure 420 is populated in descending order. In this example, descending order is opposite of the ascending order of the indices of data structure 420, so that the memory integrity region IDs start at the highest value (ID 64) at bit index 0 and descend from there so that the highest bit index 63 corresponds to the lowest ID value 1. Further in this example, the full data structure 420 may be populated, regardless of a quantity of main memory regions that are enabled for memory integrity.

The generated data structures 410 and 420 have opposite orders, where a lowest main memory region ID enabled for data integrity in data structure 410 corresponds in position with a highest memory integrity region ID 64. As the main memory region IDs increase, they correspond in position with lower values for memory integrity region IDs in this example. In another example (not shown), data structure 410 may be populated in a descending order, and data structure 420 may be populated in the opposite order (ascending).

Of course, the example of FIG. 4 is scaled for 64 main memory regions and 64 memory integrity regions. Various implementations may scale the data structures 410 and 420 as appropriate to accommodate a particular quantity of main memory regions and memory integrity regions (e.g., 128, 32, 16).

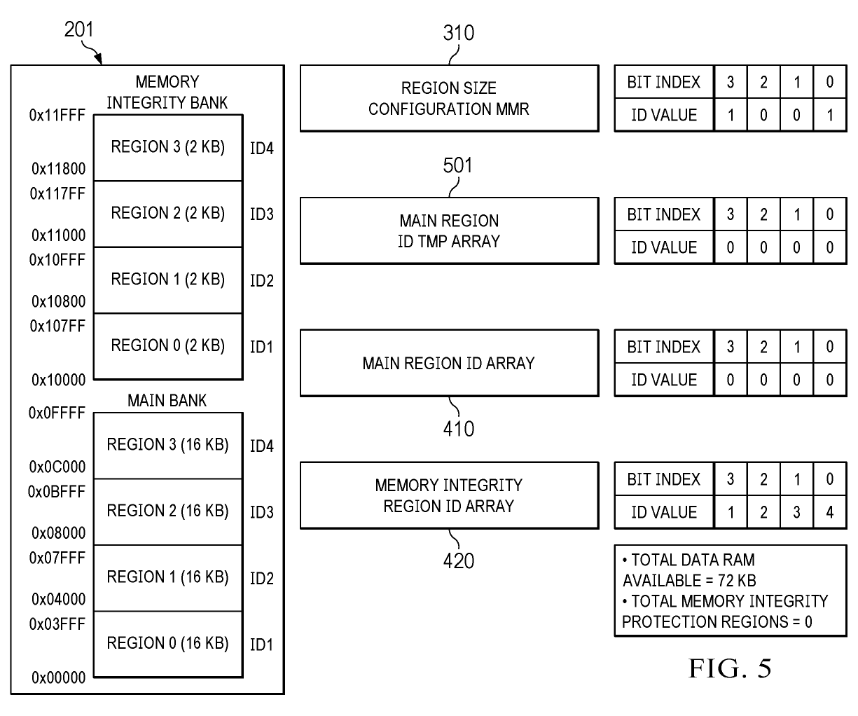

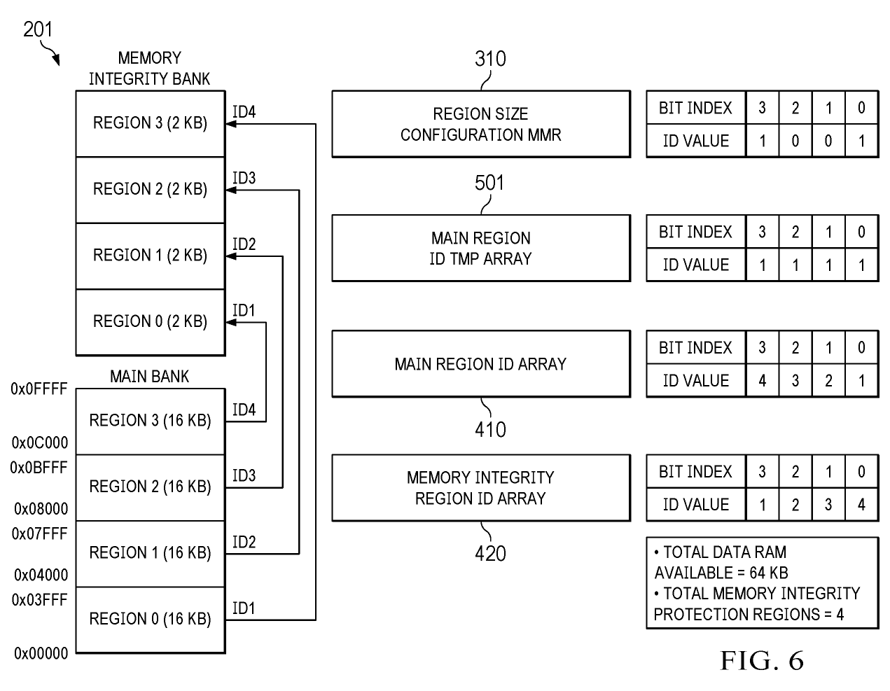

FIG. 5 is an illustration of an example embodiment in which memory banks 201 have been configured to have four main memory regions and four memory integrity regions. As noted above, the quantity of main memory regions and memory integrity regions may be scaled as appropriate, and the quantity four is used in this example for ease of illustration. Furthermore, the example of FIG. 5 assumes a single memory bank, which is divided into a main bank and a memory integrity bank. The same is true for the other examples of FIGS. 6-8.

In the present example, the memory banks 201 have four main memory regions 0-3, having main memory region IDs 1-4. The quantity of memory integrity regions is the same (0-3) having memory integrity IDs 1-4. Further in this example, memory banks 201 have a contiguous address space from 0x00000 to 0x11FFF, for a total of 72 kB. The main bank portion extends from a starting address of 0x00000 to 0x0FFFF. The memory integrity bank starts at an address 0x10000, which is adjacent to the ending address of the main bank 0x0FFFF. The memory integrity bank extends to an ending address 0x11FFF. Thus, the contiguous address space extends from the starting address of the main bank to the ending address of the parity bank without gaps.

The main bank to memory integrity bank mapping circuit 214 may be configured to arrange the main memory regions and the parity regions based at least in part on the data from MMR 310. For instance, in this example, MMR 310 may include indices 1-3, which may be populated to indicate a size of the memory regions, which in this example is 16 kB. Thus, the index 3, including a digital 1, and the indices 1-2 and 4 being populated with a digital 0, indicates 16 kB for each main memory region. The quantity of memory regions may be based on the size of memory banks 201, such that 72 kB divided by a 16 kB size allows for a total of four main memory regions with 8 kB left over.

Furthermore, the main bank to memory integrity bank mapping circuit 214 in this example may be configured to assign 2 kB sizes to each of the individual memory integrity regions, though the scope of implementations may include any appropriate size. Thus, the remainder 8 kB may be configured as four 2 kB memory integrity regions, the same quantity as the main memory regions. The index 0 of MMR 310 may indicate that MMR 310 is locked.

In the present example, since there are four main memory regions, only MMR 320 may be used, and then, only the first four bits 0-3 of MMR 320 may be relevant. The other bits 4-31 of MMR 320 and the entirety of the MMR 330 may be reserved for some other use or ignored.

Data structure 501 in this example is referred to as a main memory region ID temporary array, and it may be an intermediate step in populating main memory region ID array 410. For instance, data structure 501 may include the same data as in the MMR 320 to indicate individual main memory regions to have memory integrity enabled. In the example of FIG. 5, no main memory regions have memory integrity enabled, so bits 0-3 of MMR 320 may be populated with zeros, and data structure 510 may also be populated with zeros.

Continuing with the example, the data structure 410 may also be populated with zeros, since there are no main memory regions having memory integrity enabled. The data structure 420 is populated according to a descending order, where the memory integrity region having ID 1 corresponds to the bit having index 3 in the data structure 420, and the memory integrity region having ID 4 corresponds to the bit having index 0.

In this example, since there are no main memory regions having memory integrity enabled, the memory controller may configure memory banks 201 so that the entire contiguous address space from 0x00000 to 0x11FFF may be used for user data and none of the memory integrity regions (ID 1-ID 4) are used for memory integrity data.

FIG. 6 is another example, similar to the example of FIG. 5, though in FIG. 6 all four main memory regions have memory integrity enabled. Thus, data structure 501 reflects from the data in MMR 320 that memory regions having indices 0-3 (having IDs 1-4) correspond to a value of 1. The data structure 410 is then populated so that index 3 identifies memory region ID 4, index 2 identifies memory region ID 3, index 1 identifies memory region ID 2, and index 0 identifies memory region ID 1. Thus, in this example, the data structure 410 is populated in an ascending order from index 0 to index 3. The data structure 420 is the same as in the example of FIG. 5, being populated in a descending order from index 0 to index 3.

The corresponding bit positions in data structures 410 and 420 define the main bank and memory integrity bank relationships. Thus, the bit index 3 of data structure 410 and the bit index 3 of data structure 420 may cause main memory region ID 4 to correspond to memory integrity region ID 1, main memory region ID 3 may correspond to memory integrity region ID 2, main memory region ID 2 may correspond to memory integrity region ID 3, and main memory region ID 1 may correspond to memory integrity region ID 4. In other words, all of the main memory regions ID 1-4 and all of the memory integrity regions ID 1-4 may be enabled for memory integrity operations.

The memory controller in the example of FIG. 6 configures memory banks 201 so that the memory addresses from 0x00000 to 0x0FFF are used to store user data, and the memory addresses from 0x10000 to 0x11FFF are used to store memory integrity data. In other words, in this example, there is no additional room for user data in the memory integrity banks.

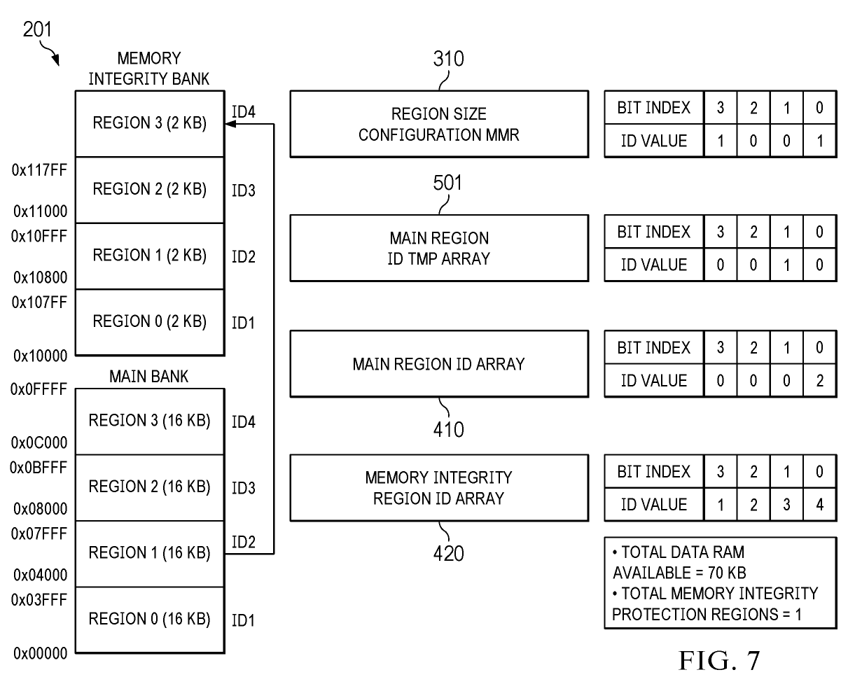

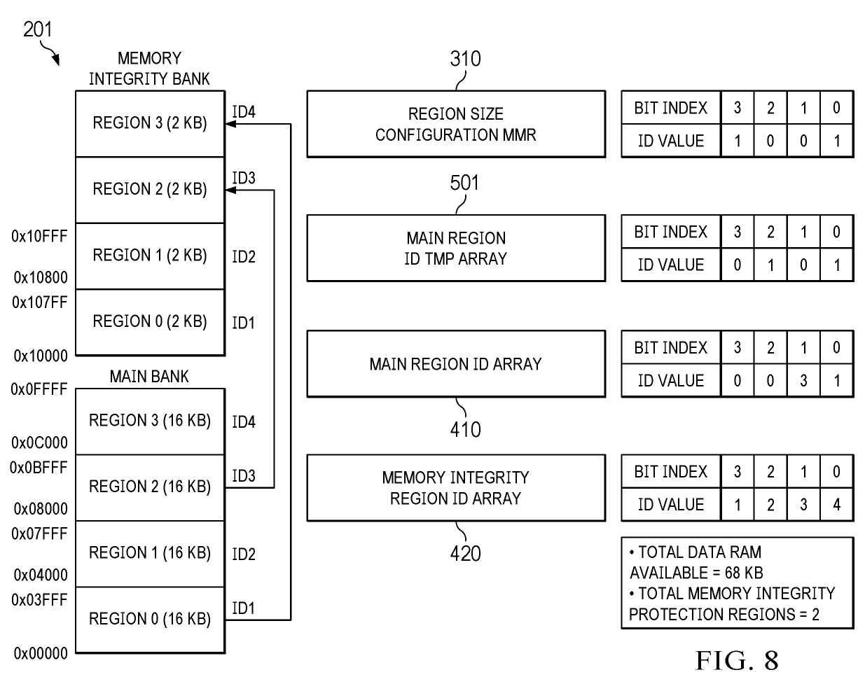

The examples of FIGS. 7 and 8 illustrate instances of partial memory integrity being enabled. Starting with FIG. 7, it illustrates an example in which a single memory region (ID 2) has memory integrity enabled.

MMR 320 may be populated so that index 1 stores a 1, and the other bits having indices 0 and 2-3 may be populated by a 0. This is reflected in the data structure 501.

The main bank to memory integrity bank mapping circuit 214 may then populate data structure 410 in an ascending order beginning at bit index 0, which is populated with main memory region ID 2 to indicate the integrity enabled main memory region 1 (ID 2). The other bit indices are populated with zeros since only main memory region ID 2 is enabled for memory integrity. Data structure 420 may be populated the same as in the other examples to indicate the available regions in the memory integrity bank. As a result, the bit position having index 0 of data structure 410 and the corresponding bit position of data structure 420 may specify that memory integrity region ID 4 corresponds to main memory region ID 2, as shown by the arrow in FIG. 7. Thus, both main memory region ID 2 and memory integrity region ID 4 are enabled for memory integrity operations. In this example, there is a total of 70 kB available for user data.

Further in this example, as a result of the configuration, the address range from 0x00000 to 0x117FF is configured to store user data and only the address range from 0x11800 to 0x11FFF is configured to store memory integrity data. Note that the address range to store user data is contiguous from start to end, beginning at the first address in the address range. The address range to store memory integrity data ends at the end of the full address range and is adjacent to the end of the address range for user data.

In FIG. 8, there are two memory regions (ID 1 and ID 3), which are indicated as having memory integrity enabled. Thus, MMR 320 may be populated so that bit positions 0 and 2 are both populated with a 1, and the other bit positions 1 and 3 are populated with 0. This is reflected in data structure 501. Data structure 410 may be populated in an ascending order so that the lowest main memory region ID number having memory integrity enabled (ID 1) is indicated at bit position 0, and the next lowest main memory region ID number having memory integrity enabled (ID 3) is indicated bit position 1. Data structure 420 is populated the same as in the other examples.

The bit positions in the data structures 410 and 420 specify that main memory region ID 1 corresponds to memory integrity region ID 4 and main memory region ID 3 corresponds to memory integrity region ID 3. Thus, main memory regions ID 1 and ID 3 as well as memory integrity regions ID 4 and ID 3 are configured for memory integrity operations.

The address range from 0x00000 to 0x10FFF is configured to store user data, and it is contiguous. The address range from 0x11000 to 0x11FFF is configured to store memory integrity data, and the end of that address range corresponds to the end of the contiguous address space. In this example, there is a total of 68 kB available to store user data.

Another feature of note in the examples of FIGS. 6-8 is that when memory integrity operations are enabled for at least one main memory region, the particular correspondence between a given main memory region and a given memory integrity region may change depending on the quantity of main memory regions having memory integrity enabled. For instance, an example of FIG. 6, main memory region ID 2 corresponds to memory integrity region ID 3, whereas in the example of FIG. 7, main memory region ID 2 corresponds to memory integrity region ID 4. This is a result of the ascending order versus descending order population of data structures 410 and 420, which allows for a contiguous address range to store user data, beginning at 0x00000 and ending at an address range at one of the memory integrity regions.

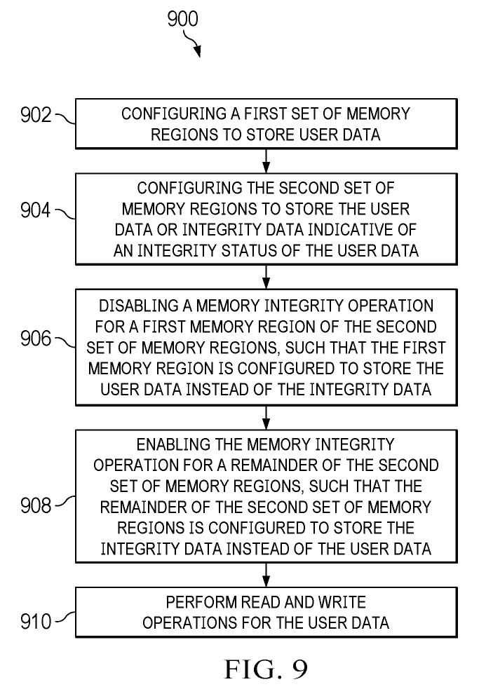

FIG. 9 is an illustration of example method 900, according to some embodiments. Method 900 may be performed, e.g., by a memory controller, such as memory controller 210 of FIG. 2 having main memory bank to memory integrity bank mapping circuit 214. In some examples, the functionality of memory controller 210 may be implemented using hardware logic, though the scope of implementations may include software functionality in addition to or instead of hardware logic.

Example method 900 is directed to partial parity enablement, such as described above with respect to FIGS. 7 and 8.

Action 902 includes configuring a first set of memory regions to store user data, and action 904 includes configuring a second set of memory regions to store user data or integrity data indicative of an integrity status of the user data. For instance, the MMRs 310, 320, and 330 may be used to indicate a size of main memory regions and, thus, a quantity of main memory regions as well as which ones of the memory regions may have memory integrity enabled. In the example of method 900, the first set of memory regions may correspond to the main memory regions, and the second set of memory regions may correspond to the memory integrity regions.

Actions 902 and 904 may include the memory controller accessing the data in the MMRs 310, 320, 330 and then configuring the memory bank 210 accordingly. For instance, in the examples of FIGS. 6-8, the memory controller configures the memory bank 210 to include four main memory regions and four memory integrity regions. However, as noted above, a quantity and size of main memory regions and memory integrity regions may be scaled as appropriate.

Action 906 includes selectively disabling a memory integrity operation for a first memory region of the second set of memory regions. In one example, only a subset of the main memory regions may have memory integrity enabled and, as a result, only a subset of the memory integrity regions may be enabled for memory integrity operations as well. For instance, in the example of FIG. 7, memory integrity regions IDs 1-3 are disabled for memory integrity and instead are configured for storing user data. In the example of FIG. 8, memory integrity regions ID 1-2 are disabled for memory integrity and instead are configured for storing user data.

Action 908 includes enabling the memory integrity operation for a remainder of the second set of memory regions. In the example of FIG. 7, memory integrity region ID 4 is enabled for memory integrity, and in the example of FIG. 8, memory integrity regions ID 3-4 are enabled for memory integrity. Thus, those regions may be configured for storing memory integrity data rather than user data. An example of user data may include data and instructions corresponding to operation of application 103, and an example of memory integrity data may include, e.g., hashes used in parity or ECC. In some embodiments, memory integrity data may be invisible to application 103.

Action 910 includes performing read and write operations for the user data. In the example of FIG. 7, read and write operations to the main memory regions ID 1 and 3-4 may be performed without any memory integrity operations. However, read and write operations to the main memory region ID 2 may be accompanied by a memory integrity operation that may include use of memory integrity data at memory integrity region ID 4. Similarly, in the example of FIG. 8, read and write operations to the memory regions ID 2 and 4 may be performed without memory integrity operations. However, read and write operations to the memory regions ID 1 and 3 may be accompanied by memory integrity operations that may include use of memory integrity data at memory integrity regions ID 3 and 4. Further, in an example in which the memory and memory controller are associated with a connectivity application (e.g., an application supporting wireless transmission) a processor core coupled to the memory may cause a wireless transceiver to transmit and/or receive data based on read and write operations. The wireless transceiver may be enabled for communications according to any appropriate protocol, such as WiFi, Bluetooth, Bluetooth Low Energy (BLE), Ultrawideband (UWB), or the like.

Of course, the scope of implementations is not limited to the series of actions described in method 900. Method 900 may also include actions corresponding to full memory integrity, as described above with respect to FIG. 6, or no memory integrity, as described above with respect to FIG. 5. In fact, method 900 may include setting configuration data so that the memory controller 210 may determine an address range for user data and an address range for memory integrity data (if appropriate) for any memory integrity scenario, whether no memory integrity, full memory integrity, or partial memory integrity.

Example embodiments of the present disclosure are summarized here. Other embodiments can also be understood from the entirety of the specification and the claims filed herein.

Example 1. An apparatus comprising: a memory comprising a first set of memory regions and a second set of memory regions, wherein the first set of memory regions is configured to store user data, and wherein the second set of memory regions is configured to store the user data or integrity data indicative of an integrity status of the user data; and a memory controller, coupled to the memory, wherein the memory controller is configured to: disable a memory integrity operation for a first memory region of the second set of memory regions, such that the first memory region is configured to store the user data instead of the integrity data.

Example 2. The apparatus according to example 2, wherein the memory controller is configured to:
enable the memory integrity operation for a remainder of the second set of memory regions, such that the remainder of the second set of memory regions is configured to store the integrity data instead of the user data.

Example 3. The apparatus according to example 1 or example 2, wherein the memory controller is further configured to:
arrange the first set of memory regions and the remainder of the second set of memory regions to be contiguous within a range of addresses in the memory.

Example 4. The apparatus according to example 3, wherein the range of addresses corresponds to a contiguous address space, wherein the first set of memory regions starts at a start of the contiguous address space, and wherein the remainder of the second set of memory regions ends at an end of the contiguous address space.

Example 5. The apparatus according to any of examples 1-4, wherein the integrity data includes parity data or error correction code (ECC) associated with the user data.

Example 6. The apparatus according to any of examples 1-5, wherein the memory controller is further configured to:
access configuration data from a first memory mapped register (MMR), wherein the configuration data of the first MMR identifies a size of each respective region of the first set of memory regions.

Example 7. The apparatus according to example 6, wherein the memory controller is further configured to:
configure the first memory regions within the memory based on the configuration data from the first MMR.

Example 8. The apparatus according to example 7, wherein the memory controller is further configured to:
access configuration data from a second memory mapped register (MMR), wherein the configuration data of the second MMR identifies which ones of the first memory regions for which memory integrity operations are to be enabled; and
enable the memory integrity operation for the first memory region of the second set of memory regions based on the configuration data of the second MMR.

Example 9. The apparatus according to example 8, wherein the memory controller is further configured to:
populate, based on the configuration data of the first MMR, a first data structure according to a first bit position to identify individual ones of the first set of memory regions;
populate, based on the configuration data of the second MMR, a second data structure according to a second bit position order, opposite to the first bit position order, wherein each bit position in the second bit position order corresponds to a respective memory region of the second set of memory regions;
and arrange the first set of memory regions and the remainder of the second set of memory regions to be contiguous within a range of addresses in the memory, and wherein the first set of memory regions and the first memory region of the second set of memory regions are arranged based on a correspondence of the bit positions of the first data structure to the bit positions of the second data structure.

Example 10. The apparatus according to any of examples 1-9, wherein each region of the first set of memory regions is larger than each region of the second set of memory regions.

Example 11. A device comprising:
a processor core;
a wireless transmitter coupled to the processor core; and
a memory coupled to the processor core,
wherein the memory is configured to:
   configure a contiguous address space of the memory for read and write operations and for storing memory integrity data, including designating N memory regions for the read and write operations; and
   enable memory integrity operations on M of the N memory regions, where N is an integer greater than one, and M is an integer less than N and greater than zero,
   wherein the processor core is configured to:
      request an access to the user data stored in the memory; and
      generate an indication based on the user data, and
      wherein the wireless transmitter is configured to:
         transmit a signal based on the indication.

Example 12. The device according to example 11, wherein the processor core is configured to:
write configuration data to a memory mapped register (MMR), wherein the configuration data specifies a size of each memory region of the N memory regions; and
wherein the memory is configured to: access the configuration data to configure the contiguous address space.

Example 13. The device according to example 12, wherein the processor core is configured to:
write additional configuration data to an additional MMR, wherein the additional configuration data specifies individual ones of the M memory regions for memory integrity operations; and
wherein the memory is configured to: access the additional configuration data to enable the memory integrity operations.

Example 14. The device according to example 11, wherein the memory is configured to:
configure an additional M memory regions within the contiguous address space to store memory integrity data according to the memory integrity operations; and
configure the contiguous address space so that the additional M memory regions extend to an end of the contiguous address space and so that the N memory regions extend from a start of the contiguous address space.

Example 15. The device according to example 14, wherein the memory is configured to:
configure a portion of the contiguous address space, extending from an end of the N memory regions and ending at a start of the additional M memory regions, for the read and write operations.

Example 16. A method comprising:
configuring, in a memory having a first set of memory regions and a second set of memory regions, the first set of memory regions to store user data; and
configuring the second set of memory regions to store the user data or integrity data indicative of an integrity status of the user data, which includes:
   disabling a memory integrity operation for a first memory region of the second set of memory regions, such that the first memory region is configured to store the user data instead of the integrity data; and
   enabling the memory integrity operation for a remainder of the second set of memory regions, such that the remainder of the second set of memory regions is configured to store the integrity data instead of the user data.

Example 17. The method according to example 16, further comprising:
arranging the first set of memory regions and the remainder of the second set of memory regions to be contiguous within a range of addresses in the memory.

Example 18. The method according to example 17, further comprising:
arranging the first set of memory regions to start at a start of a contiguous address space and arranging the remainder of the second set of memory regions to end at an end of the contiguous address space, wherein the range of addresses corresponds to the contiguous address space.

Example 19. The method according to any of examples 16-18, further comprising:
accessing configuration data in a first memory mapped register (MMR), wherein the configuration data specifies a size of each respective region of the first set of memory regions; and
configuring the memory based on the configuration data in the first MMR, including determining a quantity of the memory regions of the first set of memory regions.

Example 20. The method according to example 19, further comprising:
accessing configuration data in a second MMR, wherein the configuration data identifies which ones of the first memory regions for which memory integrity operations are to be enabled; and
enabling the memory integrity operation for the first memory region of the second set of memory regions based on the configuration data of the second MMR.

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. An apparatus comprising:
a memory comprising a first set of memory regions and a second set of memory regions, wherein the first set of memory regions is configured to store user data, and wherein the second set of memory regions is configured to store the user data or integrity data indicative of an integrity status of the user data; and
a memory controller, coupled to the memory, wherein the memory controller is configured to:
disable a memory integrity operation for a first memory region of the second set of memory regions, such that the first memory region is configured to store the user data instead of the integrity data.

2. The apparatus of claim 1, wherein the memory controller is configured to:
enable the memory integrity operation for a remainder of the second set of memory regions, such that the remainder of the second set of memory regions is configured to store the integrity data instead of the user data.

3. The apparatus of claim 2, wherein the memory controller is further configured to:
arrange the first set of memory regions and the remainder of the second set of memory regions to be contiguous within a range of addresses in the memory.

4. The apparatus of claim 3, wherein the range of addresses corresponds to a contiguous address space, wherein the first set of memory regions starts at a start of the contiguous address space, and wherein the remainder of the second set of memory regions ends at an end of the contiguous address space.

5. The apparatus of claim 1, wherein the integrity data includes parity data or error correction code (ECC) associated with the user data.

6. The apparatus of claim 1, wherein the memory controller is further configured to:
access configuration data from a first memory mapped register (MMR), wherein the configuration data of the first MMR identifies a size of each respective region of the first set of memory regions.

7. The apparatus of claim 6, wherein the memory controller is further configured to:
configure the first memory regions within the memory based on the configuration data from the first MMR.

8. The apparatus of claim 7, wherein the memory controller is further configured to:
access configuration data from a second memory mapped register (MMR), wherein the configuration data of the second MMR identifies which ones of the first memory regions for which memory integrity operations are to be enabled; and
enable the memory integrity operation for the first memory region of the second set of memory regions based on the configuration data of the second MMR.

9. The apparatus of claim 8, wherein the memory controller is further configured to:
populate, based on the configuration data of the first MMR, a first data structure according to a first bit position to identify individual ones of the first set of memory regions;
populate, based on the configuration data of the second MMR, a second data structure according to a second bit position order, opposite to the first bit position order, wherein each bit position in the second bit position order corresponds to a respective memory region of the second set of memory regions; and
arrange the first set of memory regions and the remainder of the second set of memory regions to be contiguous within a range of addresses in the memory, and wherein the first set of memory regions and the first memory region of the second set of memory regions are arranged based on a correspondence of the bit positions of the first data structure to the bit positions of the second data structure.

10. The apparatus of claim 1, wherein each region of the first set of memory regions is larger than each region of the second set of memory regions.

11. A device comprising:
a processor core;
a wireless transmitter coupled to the processor core; and
a memory, coupled to the processor core, wherein the memory is configured to:
configure a contiguous address space of the memory for read and write operations and for storing memory integrity data, including designating N memory regions for the read and write operations; and
enable memory integrity operations on M of the N memory regions, where N is an integer greater than one, and M is an integer less than N and greater than zero,
wherein the processor core is configured to:
request an access to the user data stored in the memory; and
generate an indication based on the user data, and
wherein the wireless transmitter is configured to:
transmit a signal based on the indication.

12. The device of claim 11, wherein the processor core is configured to: write configuration data to a memory mapped register (MMR), wherein the configuration data specifies a size of each memory region of the N memory regions; and
wherein the memory is configured to: access the configuration data to configure the contiguous address space.

13. The device of claim 12, wherein the processor core is configured to: write additional configuration data to an additional MMR, wherein the additional configuration data specifies individual ones of the M memory regions for memory integrity operations; and
wherein the memory is configured to: access the additional configuration data to enable the memory integrity operations.

14. The device of claim 11, wherein the memory is configured to:
configure an additional M memory regions within the contiguous address space to store memory integrity data according to the memory integrity operations; and
configure the contiguous address space so that the additional M memory regions extend to an end of the contiguous address space and so that the N memory regions extend from a start of the contiguous address space.

15. The device of claim 14, wherein the memory is configured to:
configure a portion of the contiguous address space, extending from an end of the N memory regions and ending at a start of the additional M memory regions, for the read and write operations.

16. A method comprising:
configuring, in a memory having a first set of memory regions and a second set of memory regions, the first set of memory regions to store user data; and
configuring the second set of memory regions to store the user data or integrity data indicative of an integrity status of the user data, which includes:
disabling a memory integrity operation for a first memory region of the second set of memory regions, such that the first memory region is configured to store the user data instead of the integrity data; and
enabling the memory integrity operation for a remainder of the second set of memory regions, such that the remainder of the second set of memory regions is configured to store the integrity data instead of the user data.

17. The method of claim 16, further comprising:
arranging the first set of memory regions and the remainder of the second set of memory regions to be contiguous within a range of addresses in the memory.

18. The method of claim 17, further comprising:
arranging the first set of memory regions to start at a start of a contiguous address space and arranging the remainder of the second set of memory regions to end at an end of the contiguous address space, wherein the range of addresses corresponds to the contiguous address space.

19. The method of claim 16, further comprising:
accessing configuration data in a first memory mapped register (MMR), wherein the configuration data specifies a size of each respective region of the first set of memory regions; and
configuring the memory based on the configuration data in the first MMR, including determining a quantity of the memory regions of the first set of memory regions.

20. The method of claim 19, further comprising:
accessing configuration data in a second MMR, wherein the configuration data identifies which ones of the first memory regions for which memory integrity operations are to be enabled; and
enabling the memory integrity operation for the first memory region of the second set of memory regions based on the configuration data of the second MMR.
